(19) United States
(12) Patent Application Publication
(10) Pub. No.: US 2011/0317092 A1
(43) Pub. Date: Dec. 29, 2011

(54) LIQUID CRYSTAL DISPLAY DEVICE

(76) Inventors: Hyun-Jin PARK, Gyeonggi-do (KR); Dong-Guk KIM, Gyeonggi-do (KR); Won-Ho LEE, Gyeonggi-do (KR); Jong-Hoon WOO, Gyeonggi-do (KR); Dong-Kyu YOON, Gyeonggi-do (KR)

(21) Appl. No.: 13/158,527

(22) Filed: Jun. 13, 2011

(30) Foreign Application Priority Data
Jun. 25, 2010 (KR) 10-2010-0060792

(51) Int. Cl. G02F 1/1335

(52) U.S. Cl. 349/61

(57) ABSTRACT

A liquid crystal display device includes first and second substrate facing each other; a pixel electrode and a common electrode on the first substrate and generating an electric field substantially parallel to the first substrate; a backlight unit disposed under the first substrate and providing a light to the first substrate; and a liquid crystal layer including liquid crystal molecules and disposed between the first and second substrates, wherein the liquid crystal molecules are twisted in a helical structure having an axis perpendicular to the first substrate when the electric field is not generated and untwisted along the electric field with maintaining the axis when the electric field is generated.

The present application claims the benefit of Korean Patent Application No. 10-2010-0060792 filed in Korea on Jun. 25, 2010, which is hereby incorporated by reference.

### BACKGROUND OF THE INVENTION

1. Field of the Invention

The present invention relates to a liquid crystal display (LCD) device, and more particularly, to an LCD device using a dielectric effect to have advantages in a viewing angle, a response time and a contrast ratio.

2. Discussion of the Related Art

Recently, the LCD device has been widely used as a technology-intensive and value-added device of next generation due to its low power consumption, thin profile, and portability. In general, the LCD device uses the optical anisotropy and polarization properties of liquid crystal molecules to produce an image. Due to the optical anisotropy of the liquid crystal molecules, refraction of light incident onto the liquid crystal molecules depends upon the alignment direction of the liquid crystal molecules. The liquid crystal molecules have long thin shapes that can be aligned along specific directions. The alignment direction of the liquid crystal molecules can be controlled by applying an electric field. Accordingly, the alignment of the liquid crystal molecules changes in accordance with the direction of the applied electric field and the light is refracted along the alignment direction of the liquid crystal molecules due to the optical anisotropy, thereby images displayed.

Since the LCD device including a thin film transistor (TFT) as a switching element, referred to as an active matrix LCD (AM-LCD) device, has excellent characteristics of high resolution and displaying moving images, the AM-LCD device has been widely used. Particularly, an in-plane switching (IPS) mode LCD device using a horizontal electric field is developed due to a wide viewing angle.

FIG. 1 is a cross-sectional view of the related art IPS mode LCD device. As shown in FIG. 1, a first substrate 1 faces a second substrate 2, and a liquid crystal layer 3 is interposed therebetween. The liquid crystal layer 3 includes liquid crystal molecules 5. In addition, a plurality of pixel electrodes 7 and a plurality of common electrodes 9 are disposed on the first substrate 1. The pixel electrodes 7 and the common electrodes 9 are spaced apart from each other and alternately arranged with each other. When voltages are applied to the pixel and common electrodes 7 and 9, a horizontal electric field is generated between the pixel and common electrodes 7 and 9.

With an off state, an electric field is not generated between the pixel and common electrodes 7 and 9 such that the liquid crystal molecules 5 has an initial state and the IPS mode LCD device produce a black color.

On the other hand, with an on state, a horizontal electric field is generated between the pixel and common electrodes 7 and 9 such that the liquid crystal molecules 5 are arranged along a direction of the horizontal electric field and the IPS mode LCD device produce a white color.

As mentioned above, the IPS mode LCD device driven by the horizontal electric field has an advantage in the viewing angle. However, the IPS mode LCD device has a disadvantage in a contrast ratio because of light leakage in the off state.

To overcome the disadvantage in a contrast ratio, a vertical alignment mode LCD device has been introduced. Referring to FIG. 2, which shows the related art vertical alignment mode LCD device, a first substrate 11 faces a second substrate 12, and a liquid crystal layer 13 is interposed therebetween. The liquid crystal layer 13 includes liquid crystal molecules 15.

A pixel electrode 17 is disposed on the first substrate 11 and has a slit 18. At least one protrusion 20 is formed on the second substrate 12, and a common electrode 19 is also formed on the second substrate 12. With voltages, a vertical electric field is generated between the pixel and common electrodes 17 and 19 to drive the liquid crystal molecules 15.

As mentioned above, the vertical alignment mode LCD device has an advantage in a contrast ratio. However, the vertical alignment mode LCD device has a disadvantage in a viewing angle.

Accordingly, a liquid crystal display device having both of an advantage of a viewing angle like the IPS mode LCD device and an advantage of a contrast ratio like the vertical alignment mode LCD device is required.

### SUMMARY OF THE INVENTION

Accordingly, the present invention is directed to an IPS mode LCD device that substantially obviates one or more of the problems due to limitations and disadvantages of the related art.

An object of the present invention is to provide an LCD device having advantages in a viewing angle and a contrast ratio.

Another object of the present invention is to provide an LCD device having advantages in a response property and a driving voltage.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, a liquid crystal display device includes first and second substrate facing each other; a pixel electrode and a common electrode on the first substrate and generating an electric field substantially parallel to the first substrate; a backlight unit disposed under the first substrate and providing a light to the first substrate; and a liquid crystal layer including liquid crystal molecules and disposed between the first and second substrates, wherein the liquid crystal molecules are twisted in a helical structure having an axis perpendicular to the first substrate when the electric field is not generated and untwisted along the electric field with maintaining the axis when the electric field is generated.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view of the related art IPS mode LCD device.

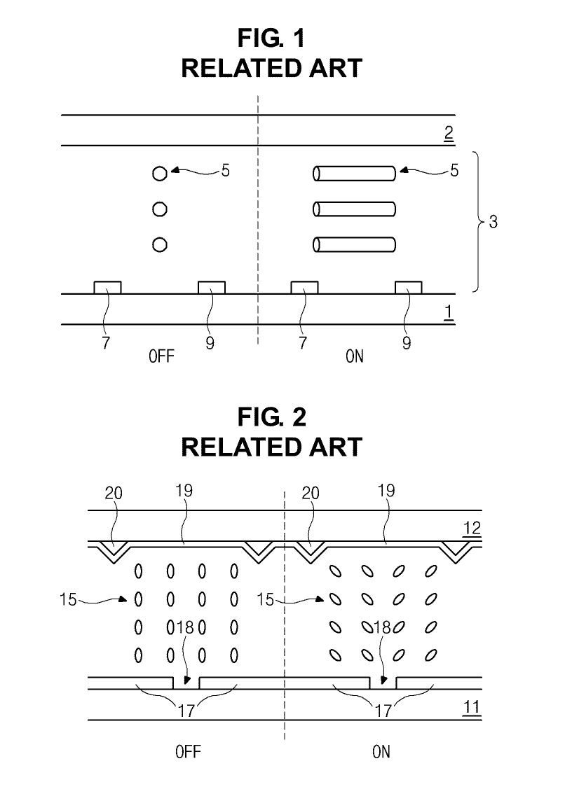

FIG. 2 is a cross-sectional view of the related art vertical alignment mode LCD device.

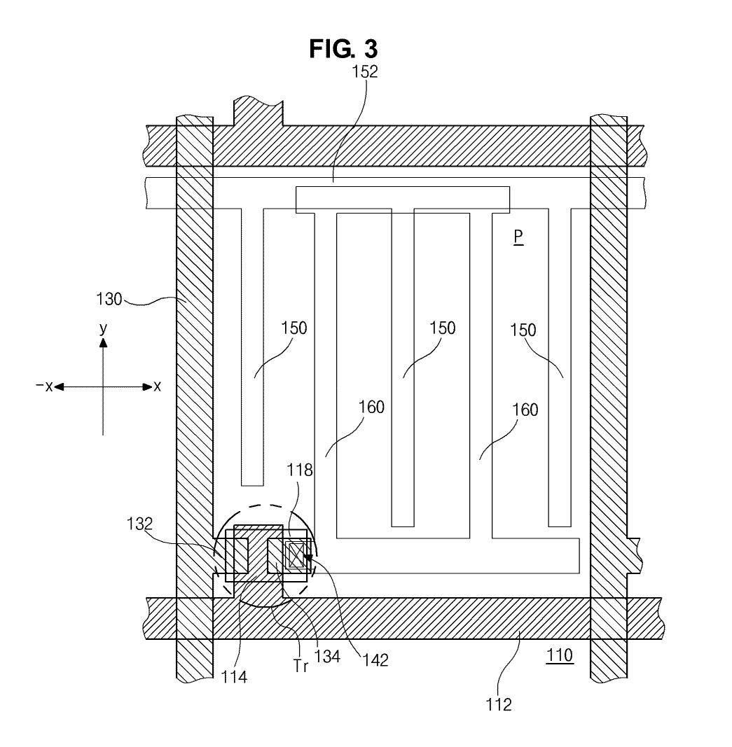

FIG. 3 is a schematic plane view of an array substrate for an LCD device according to the present invention.

FIGS. 4A and 4B are schematic cross-sectional views respectively showing off and on states of an LCD device according to the present invention.

FIGS. 5A and 5B are schematic views respectively showing an arrangement of liquid crystal molecules with on and off states of an LCD device according to the present invention.

FIG. 6 is a graph showing a relation of a driving voltage and luminescence of an LCD device according to the present invention.

FIGS. 7A and 7B are graphs respectively showing a response property of the related art IPS mode LCD device and an LCD device according to the present invention.

### DETAILED DESCRIPTION OF THE PREFERRED EMBODIMENTS

Reference will now be made in detail to the preferred embodiments, examples of which are illustrated in the accompanying drawings.

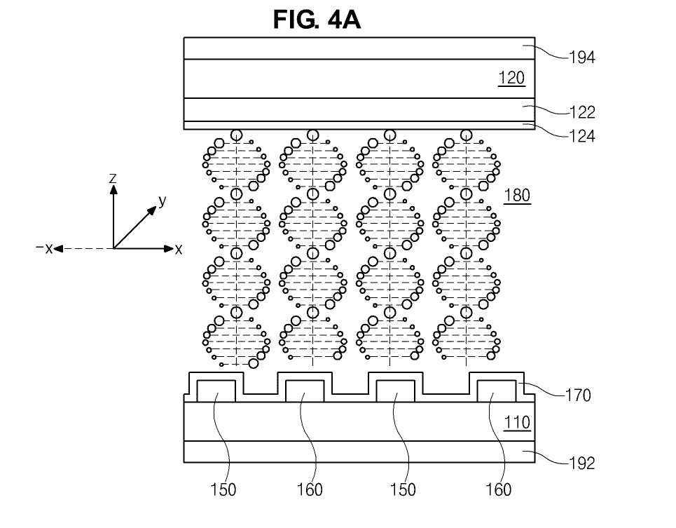

The LCD device according to the present invention uses a dielectric effect. Referring to FIG. 3, which is a schematic plane view of an array substrate for an LCD device according to the present invention, the array substrate includes a first substrate 110, a common electrode 150 and a pixel electrode 160. The common and pixel electrodes 150 and 160 are disposed on the first substrate 110 and generate an electric field. In addition, a thin film transistor (TFT) Tr as a switching element, a gate line 112 for controlling the TFT Tr, and a data line 130 for providing a voltage to the pixel electrode 150 are disposed on the first substrate 110.

The gate and data lines 112 and 130 crosses each other to define a pixel region P. The TFT Tr is connected to the gate and data lines 112 and 130. The TFT Tr includes a gate electrode 114, a gate insulating layer (not shown), a semiconductor layer 118, a source electrode 132 and a drain electrode 134. The gate electrode 114 is connected to the gate line 112, and the gate insulating layer covers the gate electrode 114. The semiconductor layer 118 is disposed on the gate insulating layer and overlaps the gate electrode 114. The source electrode 132 is connected to the data line 130 and spaced apart from the drain electrode 134. The source and drain electrodes 132 and 134 are disposed on the semiconductor layer 118.

A common line 152, which is substantially parallel to the gate line 112, is also disposed on the first substrate 110. The common line 152 is connected to the common electrode 150 such that a voltage is provided into the common electrode 150. The pixel electrode 160 is connected to the drain electrode 134 of the TFT Tr and alternately arranged with the pixel electrode 160. For example, a passivation layer (not shown), which includes a drain contact hole 142 exposing the drain electrode 134, is formed on the TFT Tr, and the pixel electrode 160 is formed on the passivation layer. The pixel electrode 160 contacts the drain electrode 134 through the drain contact hole 142. A voltage is provided into the pixel electrode 160 through the data line 130 and the TFT Tr.

When the pixel electrode 160 and the common electrode 150 are formed at the same layer and of the same material, the common line 152 is formed at a different layer from the common electrode 150. On the other hand, when the pixel electrode 160 and the common electrode 150 are formed at different layers, the common line 152 is formed at the same layer as the common electrode 150.

An electric field along an x direction or a (−x) direction is generated between the pixel and common electrodes 160 and 150, which extend along the data line 130, i.e., a y direction, such that a liquid crystal layer (not shown) is driven by the electric field.

Although not shown, a first alignment layer, which is aligned along the x direction, is disposed over the common and pixel electrodes 150 and 160. In other word, the first alignment layer is disposed between the first substrate 110 and the liquid crystal layer 180. In addition, a second alignment layer, which is aligned along the (−x) direction, is disposed on the second substrate facing the first substrate 110. In other word, the second alignment layer is disposed between the second 120 and the liquid crystal layer 180. Namely, the first alignment and the second alignment layer are aligned along the opposite direction. The liquid crystal layer is disposed between the first substrate 110 and the second substrate. The liquid crystal molecules are initially arranged with respect to the first alignment layer and the second alignment layer and driven by the electric field between the pixel electrode 160 and the common electrode 150.

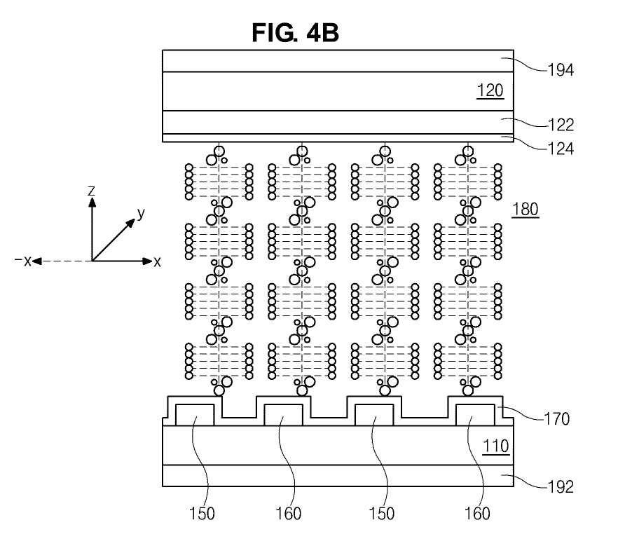

FIGS. 4A and 4B are schematic cross-sectional views respectively showing off and on states of an LCD device according to the present invention.

As shown in FIGS. 4A and 4B, the LCD device includes the first substrate 110, the second substrate 120 facing the first substrate 110, and the liquid crystal layer 180 therebetween. Although not shown, a backlight unit providing light along a z direction, which is perpendicular to the first substrate 110, is disposed under the first substrate 110.

The common electrode 150 and the pixel electrode 160 for generating a horizontal electric field are formed on the first substrate 110. In addition, the first alignment layer 170, which is aligned along a direction of the horizontal electric field, i.e., the x direction, is formed on the first substrate 110.

A color filter layer 122 is formed on the second substrate 120. The color filter layer 122 includes red, green and blue color filter patterns. The second alignment layer 124, which is aligned along the opposite direction with the first alignment layer 170, is formed on the color filter layer 122. The initial arrangement of the liquid crystal molecules in the liquid crystal layer 180 is determined by the first and second alignment layers 170 and 124. Although not shown, a black matrix for shielding the TFT Tr, the gate line and the data line may be formed on the second substrate 120.

In addition, first and second polarizing plates 192 and 194 are formed at an outer side of each of the first and second substrates 110 and 120. An axis of the first polarizing plate 192 has an angle of about 45 degrees with respect to the x direction and is perpendicular to an axis of the second polarizing plate 194.

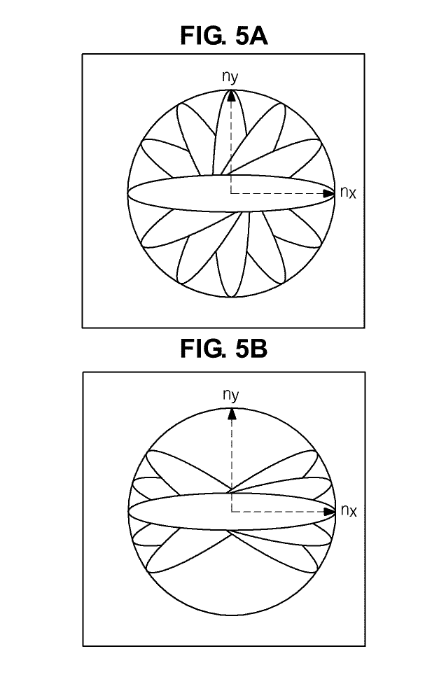

As mentioned above, the liquid crystal molecules are driven by the electric field generated by the common and pixel electrodes 150 and 160. With reference to FIGS. 5A and 5B, a driving principle is explained.

Referring to FIG. 5A, with an off state, the liquid crystal molecules has a helical twisted structure. Namely, the liquid crystal molecules are a chiral nematic liquid crystal molecule having a short pitch and are twisted dozens of times. The pitch of the helical twisted structure is shorter than a wavelength of a visible ray. For example, the pitch may be about 100 to 380 nm. An axis of the helical twisted structure is parallel to light from the backlight unit (not shown). Namely, the axis of the helical twisted structure is parallel to the z direction.

In addition, a refractive index of the liquid crystal layer 180 along the z direction is smaller than those along the x and y direction, and the refractive indexes along the x and y directions are equal. (nz<nx=ny) Namely, the liquid crystal layer 180 has an optical isotropic property at a front viewing angle such that birefringence is not produced at the front viewing angle with the off state and an excellent black color property is achieved. In other word, there is an advantage in a contrast ratio.

On the other hand, referring to FIG. 5B, with an on state, the liquid crystal molecules are untwisted along the electric field, i.e., the x direction, with the axis of the helical twisted structure of the z direction. Namely, the liquid crystal molecules, which are twisted in a helical shape with the off state, are untwisted on an axis of the axis of the helical structure with the electric field such that the liquid crystal layer 180 has an optical anisotropic property.

As a result, birefringence is produced. Since the liquid crystal layer 180 is driven by the horizontal electric field, the LCD device has an advantage in a viewing angle.

The above driving principle may be referred to as a dielectric effect. To reduce a driving voltage of the LCD device, a dielectric constant of the liquid crystal molecules is above 20. (Δε>20) Namely, since the liquid crystal molecules in the LCD device according to the present invention has the helical structure, where the liquid crystal molecules are twisted dozens of times, the liquid crystal molecules untwisted by the electric field are quickly restored to its initial state. As a result, there is an advantage in a response time. However, to drive the liquid crystal layer having the helical structure, a high driving voltage is required.

In the present invention, by using the liquid crystal molecules having a relatively high dielectric constant, it is possible to reduce the driving voltage. The dielectric constant may be 20 to 300. Beneficially, the dielectric constant may be 40 to 200.

In addition, to fast restoring to an initial state and being uniform alignment, a reactive mesogen material may be added to form a polymer network structure. Namely, when the twisted liquid crystal molecules are untwisted by the electric field, there may be a problem of not being twisted without the electric field. The polymer network structure is formed to resolve these problems. The basic structure of the liquid crystal molecules are maintained by the polymer network structure such that the problem is prevented. The added reactive mesogen material may be about 3 to 10 weight % with respect to the liquid crystal molecules, and an ultraviolet ray may be irradiated to form the polymer network structure.

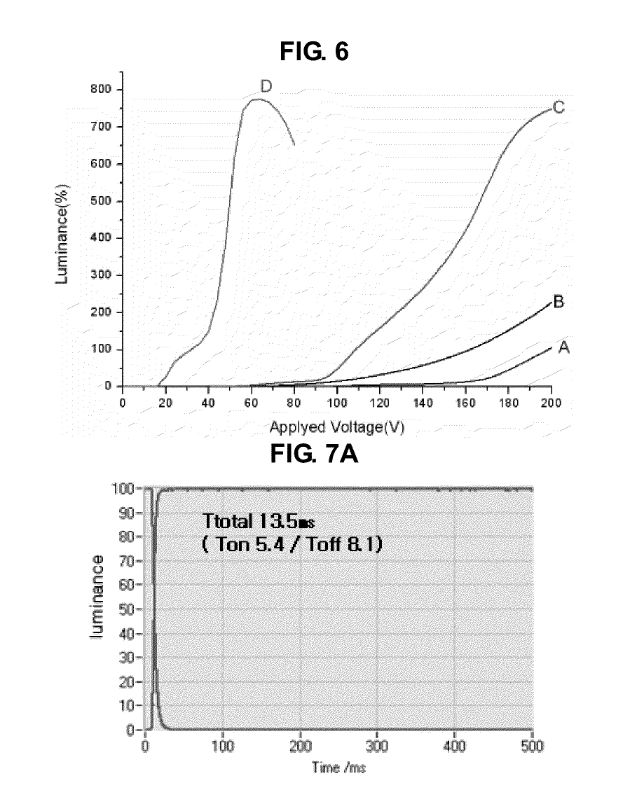

A test is performed to obtain a relation of the electric constant of the liquid crystal molecules and the driving voltage. A first sample (A) has a dielectric constant of 1.0 (Δε(A)=1.0), a second sample (B) has a dielectric constant of 3.0 (Δε(B)=3.0), a third sample (C) has a dielectric constant of 5.0 (Δε(C)=5.0), and the fourth sample (D) has a dielectric constant of 40.0 (Δε(D)=40.0). The pixel electrode and the common electrode are formed on an lower substrate, and the first and second alignment layers, which are respectively aligned along the x and (−x) directions, are respectively formed on the lower substrate and an upper substrate. The first to fourth samples at an isotropic phase are injected into a space between the first and second alignment layers, and the device is cooled into a room temperature. Then, transmittance according to a voltage is obtained and shown in FIG. 6 and Table 1.

| | A | B | C | D |
|---|---|---|---|---|
| Δε | 1.0 | 3.0 | 5.0 | 40.0 |
| driving voltage | >22 V/μm | >22 V/μm | >22 V/μm | 7.1 V/μm |

Referring to FIG. 6 and Table 1, as a dielectric constant of the liquid crystal molecules is greater, a driving voltage is lowered. Namely, with a higher dielectric constant, the LCD device produces the same luminance with a lower driving voltage due to the dielectric effect.

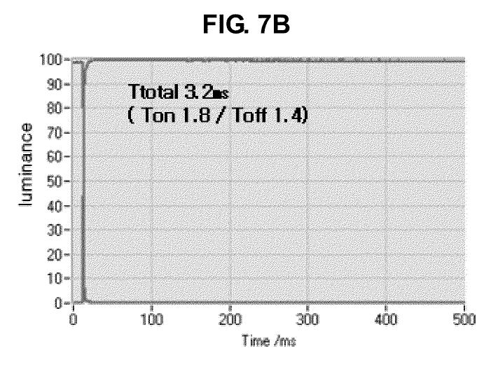

FIGS. 7A and 7B are graphs respectively showing a response property of the related art IPS mode LCD device and an LCD device according to the present invention. Referring to FIGS. 7A and 7B, a response property of the LCD device according to the present invention is improved about four times more than that of the related art IPS mode LCD device. Namely, in the present invention, the liquid crystal molecules are twisted in a helical structure without an electric field and are untwisted with the electric field due to the dielectric effect. As a result, the response time is reduced.

As mentioned above, in the LCD device according to the present invention, the chiral nematic liquid crystal molecules having a short pitch are twisted in a helical structure with an off state and are untwisted with an on state with maintaining an axis of the helical structure. As a result, the response property is improved. In addition, since the liquid crystal molecules are driven by an electric field, which is perpendicular to the axis of the helical structure, i.e., a horizontal electric field, the LCD device has a wide viewing angle.

Moreover, since the LCD device includes the liquid crystal molecules having a relatively high dielectric constant, there is an advantage in a driving voltage. Furthermore, since the liquid crystal layer 180 has an optical isotropic property at a front viewing angle, a contrast ratio is improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
first and second substrate facing each other;
a pixel electrode and a common electrode on the first substrate and generating an electric field substantially parallel to the first substrate;
a backlight unit disposed under the first substrate and providing a light to the first substrate; and
a liquid crystal layer including liquid crystal molecules and disposed between the first and second substrates, wherein the liquid crystal molecules are twisted in a helical structure having an axis perpendicular to the first substrate when the electric field is not generated and untwisted along the electric field with maintaining the axis when the electric field is generated.

2. The device according to claim 1, wherein the liquid crystal molecules have a dielectric constant above 20.

3. The device according to claim 1, further comprising:
a first alignment layer between the first substrate and the liquid crystal layer; and
a second alignment layer between the second substrate and the liquid crystal layer,
wherein one of the first and second alignment layer is aligned along a first direction substantially parallel to the electric field, and the other one of the first and second alignment layer is aligned along a second direction opposite to the first direction.

4. The device according to claim 3, further comprising:
a first polarizing plate on an outer side of the first substrate and having a first axis; and
a second polarizing plate on an outer side of the second substrate and having a second axis perpendicular to the first axis,
wherein the first and second axes have an angle of 45 degrees with respect to the first direction.

5. The device according to claim 1, wherein a pitch of the helical structure is shorter than a wavelength of a visible ray.

6. The device according to claim 1, wherein the liquid crystal molecules are a chiral nematic type.

7. The device according to claim 6, wherein a reactive mesogen is added to the liquid crystal molecules to form a polymerization network structure.

8. The device according to claim 1, further comprising:
a gate line on the first substrate and extending along a first direction parallel to the electric field;
a data line on the first substrate and extending along a second direction to cross the gate line; and
a switching element connected to the gate and data lines,
wherein the pixel electrode is connected to the switching element.

9. The device according to claim 8, wherein the pixel and common electrodes extend along the second direction and are alternately arranged with each other.

10. The device according to claim 8, further comprising:
a black matrix on the second substrate and shielding the switching element, the gate line and the data line; and
a color filter layer on the second substrate and including red, green and blue color filter patterns.
